(19) United States
(12) Patent Application Publication
(10) Pub. No.: US 2016/0059194 A1
(43) Pub. Date: Mar. 3, 2016

(54) Hydrating and Dissolving Polymers in Salt Solutions

(71) Applicant: Highland Fluid Technology, Ltd., Houston, TX (US)

(72) Inventor: Kevin W. Smith, Bellaire, TX (US)

(21) Appl. No.: 14/834,986

(22) Filed: Aug. 25, 2015

Related U.S. Application Data
(60) Provisional application No. 62/042,459, filed on Aug. 27, 2014.

(51) Int. Cl. B01F 13/06; B01F 3/12

(52) U.S. Cl. CPC B01F 13/06; B01F 3/1242

(57) ABSTRACT

Polyacrylamides, guar gum (sometimes “guar”), xanthan gum, carboxymethylcellulose, hydroxyethylcellulose, and other water-soluble polymers are dissolved and hydrated in salt solutions, including especially recycled drilling, fracturing, and other oilfield fluids having significant salt contents, by passing the water-soluble polymer to an eductor for mixing with the salt-containing solution and then to a cavitation device including an integrated disc pump. The ability to use water-soluble polymers with the salty recycled oilfield fluids has significant environmental benefits, namely (1) fresh water is not needed, (2) disposal of the environmentally undesirable returned fluids is not needed, (3) difficultly degradable synthetic polymers may not be needed, and, in particular, (4) the enhanced ability to use guar, which, being a natural product, is biodegradable, is environmentally favored.

### CROSS REFERENCE TO RELATED APPLICATION

This application claims the full benefit of U.S. Provisional Application No. 62/042,459 filed Aug. 27, 2014, which is incorporated herein by reference in its entirety.

### TECHNICAL FIELD

Polyacrylamides, guar gum (sometimes “guar”), xanthan gum, carboxymethylcellulose, hydroxyethylcellulose, and other water-soluble polymers are dissolved and hydrated in salt solutions, including especially recycled drilling, fracturing, and other oilfield fluids having significant salt contents, by passing the water-soluble polymer to an eductor for mixing with the salt-containing solution and then to a cavitation device including an integrated disc pump. The ability to use water-soluble polymers with the salty recycled oilfield fluids has significant environmental benefits, namely (1) fresh water is not needed, (2) disposal of the environmentally undesirable returned fluids is not needed, (3) difficultly degradable synthetic polymers may not be needed, and, in particular, (4) the enhanced ability to use guar, which, being a natural product, is biodegradable, is environmentally favored.

### BACKGROUND OF THE INVENTION

In the recovery of hydrocarbons from the earth, water-soluble polymers are useful for imparting viscosity to drilling fluids to aid in the transport of drill cuttings to the surface as the drill penetrates the earth. The increased viscosity of the fluid due to hydration of the high molecular weight polymer renders it better able to handle drill cuttings in the fluids.

Viscosity-imparting water-soluble polymers are also used in fracturing fluids to keep proppants in suspension while they are transported to the fractured formation. Also in connection with fracturing, they are used as friction reducers, meaning they greatly reduce the turbulence, thus conserving energy. Fracturing involves converting pump horsepower into hydraulic force downhole to fracture the formation. Because of the burst rating of the tubulars, it is very important for the polymer to fully hydrate, and hydrate quickly. Polyacrylamides are commonly used for friction reduction, but because of their very high molecular weight, they are hard to mix and are very sensitive to salt water and high shear devices used to mix them.

Both synthetic polymers, such as polyacrylamide, and organic polymers, or gums, such as guar, have been used widely in completion fluids as well as all of the above purposes. In the past, however, most water-soluble polymers have been used only in non-saline or very low salt water because they must be hydrated in order to realize their potential as water-soluble polymers. The industry has found it difficult to hydrolyze the polymers without first treating them or adding various chemicals even in salt-free water, and virtually impossible to find a practical way to hydrolyze them in water containing significant quantities of sodium chloride and other salts. Clear completion fluids, for example, are typically high in bromides or formates, can weigh up to 22 pounds per gallon, and also present difficult hydration problems for operators wishing to add polymers to them. Furthermore the polymers are often used in cold ambient temperatures, and cold further retards the hydration of virtually all water-soluble polymers. As fresh water sources become more and more difficult to find, the industry has looked to find better ways to utilize salt-containing water—not only used “flowback” fluids, but also the plentiful salt water available to off-shore facilities.

Whether aqueous drilling fluids and aqueous fracturing fluids are used in arid areas or in areas having a more plentiful water supply, it is increasingly attractive to reuse them. Fluids returned to the surface from the earth are highly likely to contain significant amounts of salt, but their viscosities are reduced from dilution, breakdown of the original viscosity-inducing agents, and various chemical reactions. A practical way to introduce guar gum, as well as polyacrylamide and other viscosifiers, to the returned, salt-containing, fluids is needed so they can be recycled.

One of the practical difficulties of using any polymer is the need to dissolve it. It is well known that the highly efficient viscosifying water-soluble polymers are difficult to dissolve because it requires so little of the active ingredient to generate a highly viscous solution; therefore feeding the dry material to the water must be done carefully to avoid clogging. A simplified, direct way of dissolving guar in salt water is needed. The solubility and hydration of most polymers drops as the salinity of the aqueous solvent increases. Slower hydration time means the benefit of hydration is lost until it fully hydrates. In the case of a friction reducer, one only has seconds before one needs the polymer to reduce friction to maintain pump pressures below the burst pressure of the tubulars. Because of the volumes used and the short time required, most polymers are mixed and used continuously, further requiring fast hydration; however, it can make sense to use a smaller hydration device to make a concentrated polymer solution that is further diluted in a separate step.

### SUMMARY OF THE INVENTION

I feed dry polymer from a hopper to an eductor having a source of salt water (which may be a recycled oil field fluid), causing the polymer to mix in the eductor. While mixing, the polymer/salt water mixture is passed directly to a cavitation device equipped with an integrated disc pump. The integrated disc pump rotates with the cavitation device rotor, and assures that the mixture is propelled into the confined working space of the cavitation device, which heats as well as intimately mixes the components of the fluid. Extensive hydration of the polymer takes place in the confines of the modified cavitation device; hydration may continue to an extent after the solution exits the device because of the temperature and turbulence in the exit conduit. The hydrated polymer solution may be used immediately as a drilling or fracturing fluid, as an ingredient of one, or as a friction reducing solution.

Dry polymers that can be treated by my invention include natural and synthetic polymers. Examples of natural polymers are guar gum, various derivatives of guar, Xanthan gum and its derivatives, starch, and various derivatives of cellulose such as hedroxyethylcellulose (HEC) and carboxymethylhydroxyethylcellulose (CMHEC). There are numerous synthetic polymers having water-soluble monomers in them, as is known in the art. Some of the synthetic polymers used in water treatment and in various oil field fluids include polyacrylamide, copolymers of acrylamide with other acrylic monomers and monomers of different structures such as dimethyl diallyl ammonium chloride (DMDAAC), and various copolymers of acrylamide methyl sulfonic acid (AMPS). The polymers may be considered predominantly anionic, cationic or nonionic. My invention is applicable to any water soluble polymer.

Incorporating the disc pump with the cavitation device eliminates a tank. Normally an eductor must discharge into a tank since any back pressure would flood the eductor and fill the hopper with water. Because the disc pump pulls water into the hydration device, there is no need for a second tank and a second pump.

My apparatus and method may be used also with concentrated solutions of polymer to dilute them and render them more easily handled, again with a minimum of equipment.

### BRIEF DESCRIPTION OF THE DRAWINGS

FIG. 1 is a diagram of my invention apparatus for use with dry polymer.

FIG. 2 shows a variation of the invention to describe treating and recycling polymer solution.

FIG. 3 illustrates further versatility of the invention, showing two of my units arranged for operation in series or parallel.

### DETAILED DESCRIPTION OF THE INVENTION

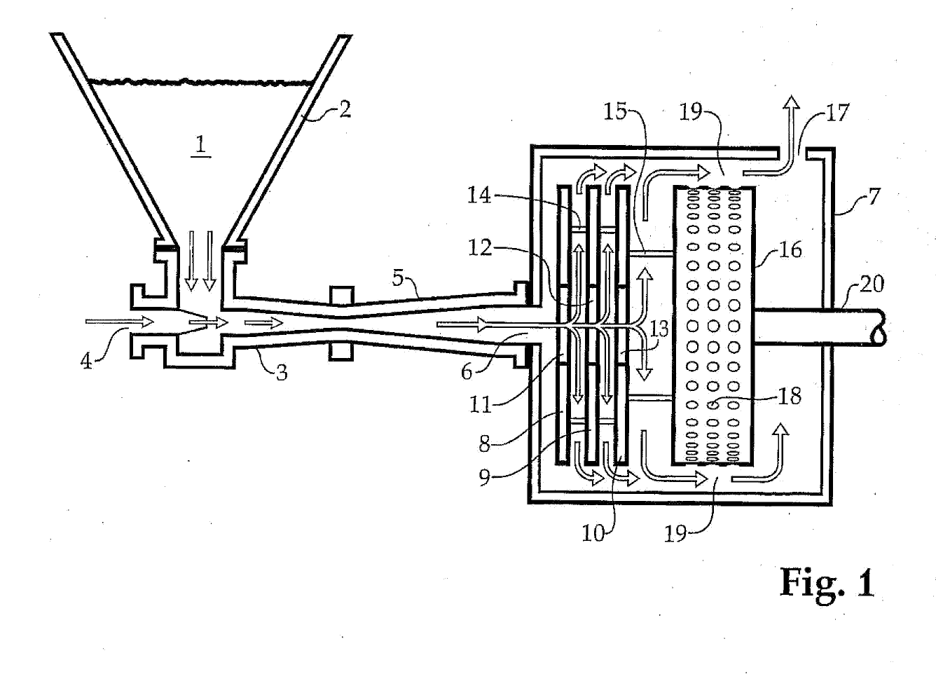

Referring now to FIG. 1, my method will be discussed with respect to feeds of dry powdered or flake polymer and brackish or salt water. Dry guar gum, polyacrylamide or other water-soluble polymer 1 in hopper 2 is fed directly into eductor 3 having an inlet 4 for salt-containing water such as a recycled or produced oil field fluid, or ocean water, which enters inlet 4 from a source not shown. The dry polymer mixes with the salt-containing water immediately on contact in the eductor, which includes a venturi 5 as is known in the art. The mixture passes from the venturi 5 through inlet 6 of the generally cylindrical housing 7 of the integrated disc pump and cavitation device.

The disc pump portion of the integrated disc pump cavitation device comprises three discs 8, 9, and 10 in substantially parallel planes, each having a central orifice 11, 12, and 13. The discs 8, 9, and 10 are held in place by supports 14 and 15 so that they will rotate with cavitation rotor 16. Rotation of the discs 8, 9, and 10 will cause the mixture entering housing 7 to flow through the integrated disc pump cavitation device whether or not the salt-containing water at inlet 4 is under an external positive pressure.

The mixture follows the arrows within housing 7, ultimately leaving through exit 17. Cavitation rotor 16, mounted on shaft 20 connected to a motor not shown, has a plurality of cavities 18 on its cylindrical surface. In the restricted space 19 between the cylindrical surface and housing 7, the fluid tends to enter the cavities but is immediately flung out by centrifugal force, causing small vacuum effects in the cavities, which are immediately filled; this fairly violent mini-action accelerates the mixing and dispersion of the polymer in the water, enabling rapid hydration of the polymer.

I have illustrated the invention with three discs 8, 9, and 10, but one or two may be effective for some purposes, and there may be as many as eight or ten; I prefer at least two discs but, as a practical matter, if there are more than five or six discs, it may be beneficial to lengthen shaft 20 so that it will pass through all orifices 11, 12, and 13 and be steadied by a collar fixed centrally near inlet 6. This will add to the cost and may not be necessary especially if any of the product solution is to be recycled.

The same equipment can be used to further dissolve highly concentrated solutions of polymer rather than dry polymer. That is, the hopper 2 will contain a concentrated solution of polymer made elsewhere instead of dry polymer as described above with reference to FIG. 1. This concentrated solution in hopper 2 may be quite viscous, but can be fed into eductor 3 by gravity or with the aid of a negative pressure exerted by the disc pump comprising discs 8, 9, and 10. Aqueous fluid from inlet 4 immediately begins to dilute the solution as they are mixed in eductor 3, and further hydrates the polymer as it follows the turbulent paths around discs 8, 9, and 10. In the constricted area between the rapidly turning cylinder 16 and the closely conforming internal surface of housing 7, the solution and some partially hydrolyzed polymer are subjected to the cavitation effect, which heats them as well as thoroughly mixes them, causing a great increase in surface area contact between the solution and any remaining unhydrolyzed polymer.

Four experiments were performed in a cavitation device similar to FIG. 1. The produced water used was from the Permian Basin and contained 120,000 ppm chlorides. Viscosity measurements were done with a Fann 35 using a B2 bob at 300 rpm and viscosity measured in about 2 minutes.

### EXAMPLE 1

Guar and water were mixed in a pail in a ratio of 40 pounds dry guar to 1000 gallons water and then run through a cavitation device similar to that of FIG. 1. Viscosity of 22 cps in the pail was increased to 33 cps after exiting the cavitation device, a 50% increase.

### EXAMPLE 2

Produced water from an oil field was mixed with an equal amount of fresh water and this brackish water was mixed in a pail at a ratio of 40 pounds of dry guar to 1000 gallons of brackish water, then run through the cavitation device similar to FIG. 1. At 2 minutes the hydration, as measured by viscosity, was increased from 18 cps to 33 cps, an 83% increase; at 3 minutes the 22.5 cps viscosity in the pail was increased to 34.5 cps, a 53% increase.

### EXAMPLE 3

100% produced water was mixed in a pail with dry guar, in a ratio of 25 pounds to 1000 gallons of water. After running through the cavitation device, the viscosity in the pail of 11 cps was increased to 21 cps, a 91% increase.

### EXAMPLE 4

100% produced water was mixed in the pail with dry guar in a ratio of 40 pounds guar to 1000 gallons of water, and run through the cavitation device as in the other examples. A viscosity of 15 cps was increased to 32 cps, an increase of 113%.

The conclusion for the experiments was that controlled cavitation speeds up the hydration of dry guar, and the most dramatic increase is in salt waters. In 100% salt water, the guar hydrated and developed viscosity the same as in both fresh water and salt water diluted by 50%.

Whether hopper 2 contains dry polymer or a concentrated solution, the aqueous fluid fed through inlet 4 may be plain water, brackish or salt water. It can be added to plain water, brackish, or salt water to provide a solution of friction reducer, or it may be added to a used drilling or fracturing fluid to make a reconstituted drilling or fracturing fluid.

It should be understood that hopper 2 is illustrative. Any effective means or device for feeding polymer into eductor 3 may be used. A control valve may regulate the rate of feed of polymer into eductor 3, whether the polymer is dry or a concentrated solution. Likewise, the rate of intake of the aqueous solvent through inlet 4 may be regulated by any satisfactory means. Eductor 3 may be any convenient eductor having two inlets and a venturi.

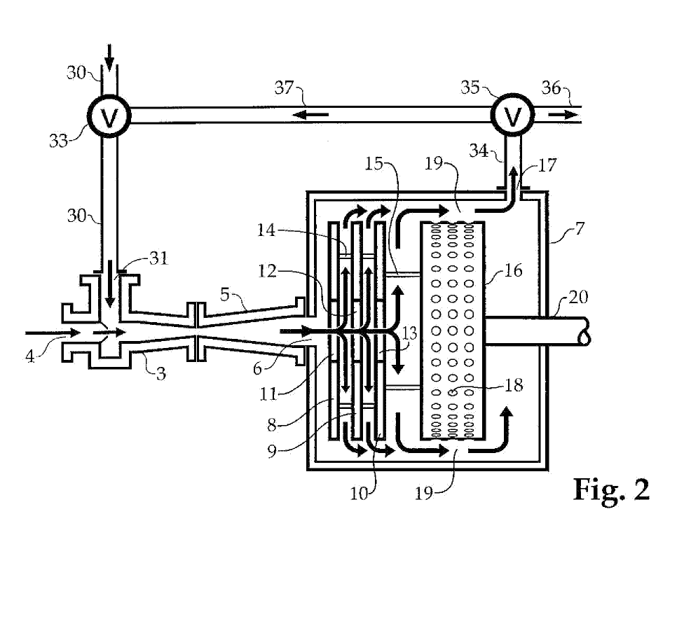

Referring now to FIG. 2, it will be seen that the hopper 2 of FIG. 1 has been removed and replaced by a conduit 30 for introducing a concentrated solution of polymer from a source not shown into eductor 3 by way of inlet 31. The solution passes through a valve 33 which may be used to control the rate of introduction of the solution into eductor 3. Any other or additional control valves or devices may be used to regulate the introduction of the solution.

Also seen is conduit 34 at exit 17 of housing 7, taking the processed solution from housing 7 to valve 35, from which it may be conveyed through conduit 36 to be used or stored. Valve 35 may also direct a portion of the processed solution through conduit 37 back to valve 33 for recycling to eductor 3. The processed solution in conduit 37 may be mixed with the incoming concentrated solution in conduit 30 on its way to the eductor 3. A viscometer may be inserted in conduit 37 or elsewhere in the recycle loop to help determine the position of valves 35 and 33. If desired, the recycled processed solution in conduit 37 may be injected directly into the incoming salt water prior to entering inlet 4, instead of or in addition to adding it in conduit 30.

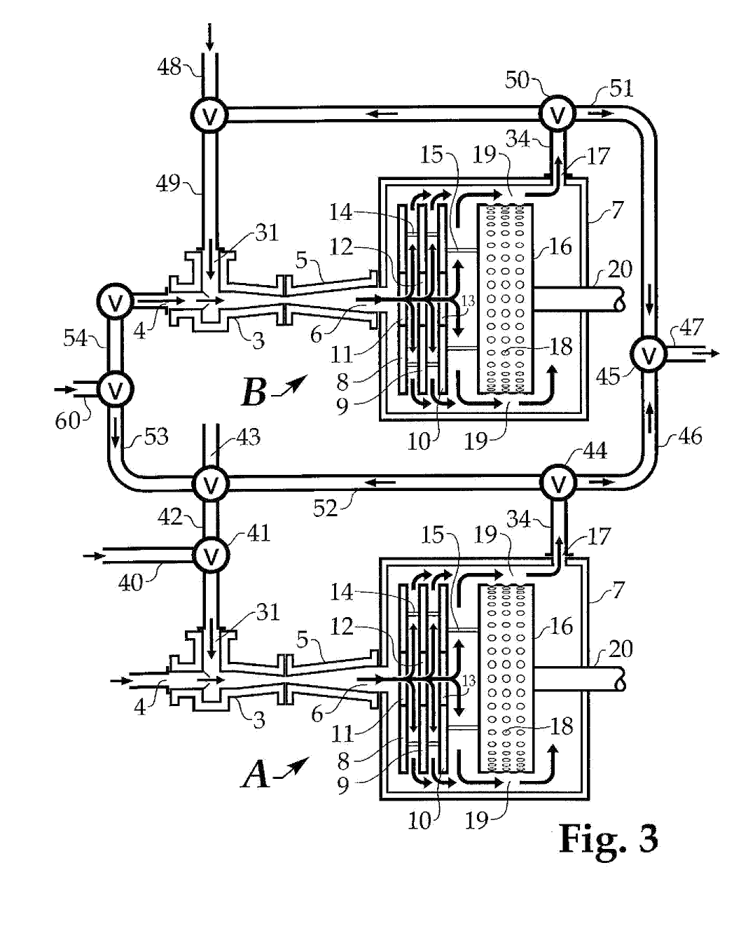

In FIG. 3, two units designated A and B, each similar to the apparatus of FIG. 2, are connected for hydrating, diluting or dissolving various materials, but operation will be described first for dissolving polymer in salt water. Shaft 20 of unit A is turned by a motor not shown, which rotates both the cavitation rotor 16 and discs 8, 9, and 10 of unit A. As explained with reference to FIG. 1, rotation of discs 8, 9, and 10 generates a pumping action which draws salt water from a source not shown through inlet 4 of eductor 3 of unit A. A polymer to be hydrated, dissolved, or diluted also is introduced to eductor 3 of unit A, by way of inlet 31. The polymer may be dry as in the hopper 2 of FIG. 1 or a concentrated solution, it being understood that by a concentrated solution of polymer I mean one which is quite viscous although it may contain only a very small amount of polymer. The concentrated solution may be introduced through conduit 40 and valve 41, or from conduit 42 having a source 43. The dry, concentrated, or partly dissolved polymer and the salt water are mixed and further dissolved within housing 7 of unit A as described with respect to FIGS. 1 and 2, leaving unit A from exit 17 into conduit 34.

For parallel operation of units A and B, valves 44 and 45 are adjusted to send the processed material from unit A through conduits 46 and 47. Normally, parallel operation means both units A and B will operate substantially identically. In this example, salt water from source 60 will enter unit B through its inlet 4 (by way of conduit 54) and dry polymer or concentrate will enter inlet 31 of unit B from source 48 or otherwise through conduit 49 into eductor 3 of unit B. Turning shaft 20 of unit B will induce the mixing materials from eductor 3 to be further mixed and subjected to the cavitation action of the cavitation device as described elsewhere. The thoroughly mixed materials, now hydrated, dissolved and/or diluted, emerge at exit 17 of unit B and are sent by valve 50 through conduit 51 to join the similar processed fluid from unit A at valve 45 to be sent to storage or use through conduit 47. Parallel operation has been described in the situation where both units A and B process the same materials, but it should be understood that different materials may be introduced into the two units and brought together at valve 45.

In series operation, the finished processed material from unit A is utilized as a feed material for unit B. The two materials mixed in eductor 3 of unit A, further mixed by the discs 8, 9, and 10 of unit A, and further processed by cavitation within housing 7 are sent by valve 44 through conduits 52, 53 and 54 to inlet 4 of eductor 3 of unit B, where it is mixed with one of the ingredients introduced in unit A or a third material, from conduit 49. Alternatively, the mixture in conduit 54 may become the source material 48. The new combination in eductor 3 of unit B is processed by unit B as previously described, emerging in conduit 34, from which it may be sent to conduit 47 for use or storage. In a variation of the series mode, part of the material in conduit 34 of unit A may be recycled to either conduits 48 and 49 of unit B or 43 and 42 of unit A and reprocessed as described with reference to FIG. 2.

Many different materials may be processed in my apparatus. For example, a water-soluble polymer could be crosslinked by sending a solution of polymer through one inlet of an eductor and a crosslinking agent could be introduced through the other. Forming a crosslinked polymer will in almost all cases substantially increase the viscosity of the solution, but the apparatus can readily handle it. As another example, fresh water may be used where I speak of salt water. The cavitation device being excellent for mixing and heating, various chemical reactions can be performed in my apparatus.

In either parallel or series operation, recycling may be performed within either unit A or unit B in the manner described with respect to FIG. 2, while also conducting either parallel or series operation. Parallel and series operation may be conducted with more than two units. Using three or more units, parallel and series operations can be combined.

A great advantage of my invention is that the cavitation action enables maximum hydration of the polymers even using very high concentrations of salts. Seawater, typically having about 35,000 milligrams per liter (mg/l) chloride, and “produced” waters (water removed from the earth in the hydrocarbon production process), not uncommonly having very high concentrations of chlorides up to 200,000 mg/l, are readily handled by the cavitation device operated to hydrate virtually any water soluble polymer. The polymers themselves tend to react differently to salt, but the mini-violent cavitation action can overcome any difficulties posed by a particular brine, including ones containing high concentrations of bromides, common in clear completion fluids. Thus my invention is applicable to the use of brackish fluids, sometimes defined as containing from 1000 to 5000 mg/l salt, as well as very high content salt water such as ocean water, seawater and gulf water as in the Gulf of Mexico, which may be slightly less salty than the open ocean because of significant fresh water from rivers. My use of the term “salt water” is intended to include brackish water as defined above as well as, in oil field terminology, “produced water,” meaning brackish water which emerges from wells along with produced hydrocarbons or as a consequence of producing the hydrocarbons, and clear completion fluids, which may contain significant quantities of bromides or formates. Clear completion fluids commonly also meet the definitions of salt water or brackish water. Having the ability to mix and heat means my invention is also applicable to the use of fresh water to conduct various chemical reactions.

Thus my invention includes a method of hydrating dry polymer in salt water comprising (a) contacting the dry polymer with the salt water in an eductor, (b) flowing the salt water and the polymer from the eductor into a rotating disc pump, (c) passing the salt water and polymer from the disc pump to a cavitation device, and (d) operating the cavitation device to intimately mix and heat the polymer and the salt water.

My invention also includes an apparatus for dissolving and hydrating water soluble polymer comprising (a) an eductor (b) a cavitation device having a cavitation rotor for rotation within a substantially cylindrical housing, and (c) a disc pump, the disc pump being adapted to receive a mixture comprising polymer and water from the eductor and pass it to the cavitation device, the disc pump also adapted to rotate with the cavitation rotor.

And, my invention includes a method of diluting a concentrated solution of water soluble polymer with salt water comprising (a) contacting the concentrated solution with the salt water in an eductor, (b) flowing the salt water and the concentrated solution from the eductor into a rotating disc pump, and (c) passing the salt water and concentrated solution from the disc pump to a cavitation device, and (d) operating the cavitation device to intimately mix and heat the concentrated solution and the salt water.

1. Method of hydrating dry polymer in salt water comprising (a) contacting said dry polymer with said salt water in an eductor, (b) flowing said salt water and said polymer from said eductor into a rotating disc pump, (c) passing said salt water and polymer from said disc pump to a cavitation device, and (d) operating said cavitation device to intimately mix and heat said polymer and said salt water.

2. Method of claim 1 wherein said dry polymer comprises a natural polymer.

3. Method of claim 1 wherein said dry polymer comprises a synthetic polymer.

4. Method of claim 1 wherein said disc pump and said cavitation device are operated by the same motor.

5. Method of claim 1 wherein said salt water comprises a brackish oil field fluid.

6. Method of claim 5 wherein said salt water is a produced fluid or a clear completion fluid.

7. Apparatus for dissolving and hydrating water soluble polymer comprising (a) an eductor (b) a cavitation device having a cavitation rotor for rotation within a substantially cylindrical housing, and (c) a disc pump, said disc pump being adapted to receive a mixture comprising polymer and water from said eductor and pass it to said cavitation device, said disc pump also adapted to rotate with said cavitation rotor.

8. Apparatus of claim 7 wherein said disc pump comprises at least two discs.

9. Apparatus of claim 8 wherein said at least two discs have central orifices.

10. Apparatus of claim 7 including a hopper for feeding polymer into said eductor.

11. Apparatus of claim 7 including a recycle loop for conducting said mixture comprising polymer and water from said cavitation device to said eductor.

12. Apparatus of claim 7 connected in series with at least one other apparatus of claim 7.

13. Apparatus of claim 7 connected in parallel with at least one other apparatus of claim 7.

14. Method of diluting a concentrated solution of water soluble polymer with salt water comprising (a) contacting said concentrated solution with said salt water in an eductor, (b) flowing said salt water and said concentrated solution from said eductor into a rotating disc pump, and (c) passing said salt water and concentrated solution from said disc pump to a cavitation device, and (d) operating said cavitation device to intimately mix and heat said concentrated solution and said salt water.

15. Method of claim 14 wherein said water soluble polymer is a natural polymer.

16. Method of claim 14 wherein said water soluble polymer is a synthetic polymer.

17. Method of claim 14 wherein said disc pump and said cavitation device are operated by the same motor.

18. Method of claim 14 wherein said salt water is ocean water, gulf water, or water produced in an oil field.

19. Method of claim 14 wherein said salt water is a used oil field fluid.

20. Method of claim 14 including recycling a portion of said intimately mixed and heated concentrated solution and salt water from said cavitation device to said eductor.
